(19) United States
(12) Patent Application Publication
(10) Pub. No.: US 2024/0226759 A1
(43) Pub. Date: Jul. 11, 2024

(54) SHOW EFFECT SYSTEM FOR AN AMUSEMENT PARK

(71) Applicant: Universal City Studios LLC, Universal City, CA (US)

(72) Inventors: Gregory Shellman Hall, Orlando, FL (US); Gregory Rell, Orlando, FL (US)

(21) Appl. No.: 18/400,496

(22) Filed: Dec. 29, 2023

Related U.S. Application Data
(60) Provisional application No. 63/478,725, filed on Jan. 6, 2023.

(51) Int. Cl. A63G 31/12; G06T 13/40; H04N 13/363

(52) U.S. Cl. CPC A63G 31/12; G06T 13/40; H04N 13/363

(57) ABSTRACT

An amusement park system includes an animated figure having one or more actuators configured to adjust a shape of a surface. The amusement park system also includes a projector configured to project imagery onto the surface and a controller configured to determine target imagery, instruct an actuator of the one or more actuators to actuate to adjust the shape of the surface based on the target imagery, generate output imagery based on the target imagery, and instruct the projector to project the output imagery onto the surface.

### CROSS REFERENCE TO RELATED APPLICATIONS

This application claims priority to and the benefit of U.S. Provisional Application Ser. No. 63/478,725, filed Jan. 6, 2023, entitled “SHOW EFFECT SYSTEM FOR AN AMUSEMENT PARK,” which is hereby incorporated by reference in its entirety for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Throughout amusement parks and other entertainment venues, special effects may be used to help immerse guests in the experience of a ride or attraction. Immersive environments may include three-dimensional (3D) props and set pieces, robotic or mechanical elements, and/or display surfaces that present media. In addition, the immersive environment may include audio effects, smoke effects, and/or motion effects. Thus, immersive environments may include a combination of dynamic and static elements. The special effects may enable the amusement park to provide creative methods of entertaining guests, such as by simulating real world elements in a convincing manner.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In an embodiment, an amusement park system includes an animated figure having one or more actuators configured to adjust a shape of a surface. The amusement park system also includes a projector configured to project imagery onto the surface and a controller configured to determine target imagery, instruct an actuator of the one or more actuators to actuate to adjust the shape of the surface based on the target imagery, generate output imagery based on the target imagery, and instruct the projector to project the output imagery onto the surface.

In an embodiment, a non-transitory computer-readable medium includes processor input instructions that, when executed by a processor, are configured to cause the processor to determine target imagery, determine a target face shape of an animated figure based on the target imagery, instruct an adjustment of one or more actuators of the animated figure based on the target face shape to adjust a shape of a surface of the animated figure, generate image data based on the target imagery, and transmit the image data to a projector and instruct the projector to project output imagery based on the image data onto the surface of the animated figure.

In an embodiment, an amusement park system includes an animated figure having one or more actuators, one or more sensors configured to capture first imagery of a person, a projector configured to project second imagery onto the animated figure, and a controller communicatively coupled to the one or more sensors. The controller is configured to receive sensor data indicative of the first imagery of the person from the one or more sensors, instruct the one or more actuators of the animated figure to actuate based on the sensor data to adjust a shape of a face of the animated figure, generate the second imagery based on the first imagery, and cause the projector to project the second imagery onto the face of the animated figure having the shape adjusted based on the sensor data to mimic an appearance of the person.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of an amusement park system, in accordance with an aspect of the present disclosure;

FIG. 2 is a perspective view of an embodiment of a show effect system that operates to present an animated figure with a realistic appearance, in accordance with an aspect of the present disclosure;

FIG. 3 is a perspective view of an embodiment of a show effect system that operates to present an animated figure with a realistic appearance, in accordance with an aspect of the present disclosure;

FIG. 4 is a perspective view of an embodiment of a show effect system that operates to present an animated figure with a realistic appearance, in accordance with an aspect of the present disclosure;

FIG. 5 is a flowchart of an embodiment of a method for operating a show effect system to present an animated figure with a realistic appearance, in accordance with an aspect of the present disclosure;

FIG. 6 is a flowchart of an embodiment of a method for operating an animated figure to output audio effects, in accordance with an aspect of the present disclosure; and

FIG. 7 is a flowchart of an embodiment of a method for operating a show effect system to present an animated figure with a realistic appearance, in accordance with an aspect of the present disclosure.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Embodiments of the present disclosure are directed to a system of an amusement park. The amusement park may include various attraction systems, such as a ride (e.g., a roller coaster, a water ride, a drop tower), a performance show, a walkway, and so forth, with features that may entertain guests at the amusement park. The amusement park may also include a show effect system configured to operate to present various effects, such as visual effects and/or audio effects, to the guests. For example, the show effect system may be a part of an attraction system and may present special effects to guests within the attraction system, such as guests within a ride vehicle of the attraction system, at a queue of the attraction system, in an auditorium of the attraction system, and the like. Additionally or alternatively, the show effect system may be external to any attraction system and may for instance, present show effects to guests at a pathway, a dining area, a souvenir shop, and so forth of the amusement park. The show effect system may provide an immersive environment for the guests to entertain the guests.

The special effects provided by the show effect system may for instance, include an animated figure (e.g., a robot). The animated figure may be movable or stationary. It may be desirable to provide the animated figure with a realistic appearance to enhance the immersive experience provided to the guests. For example, a projector may be operated to project imagery onto the animated figure. The imagery may create a more lifelike appearance of the animated figure to present the animated figure in a realistic (e.g., lifelike) and convincing manner.

Accordingly, embodiments of the present disclosure are directed to a show effect system that operates to improve the realistic appearance of the animated figure. In some embodiments, target imagery representative of a desired appearance of the animated figure may be determined. A shape of the animated figure may be adjusted based on the target imagery, and output imagery may be projected onto the animated figure based on the target imagery. As such, the shape of the animated figure and the projection onto the animated figure may cooperatively cause the appearance of the animated figure to emulate the target imagery more closely. For instance, the show effect system may operate to adjust an appearance of a face of the animated figure. Facial actuators may be operated to adjust a face shape of the face of the animated figure. Imagery may then be projected onto a surface of the face having the adjusted face shape. As a result, an appearance of the face having the adjusted face shape and the projected facial imagery may closely mimic the target imagery. By way of example, the target imagery may be of a real-world element, such as captured imagery of an object or person (e.g., a guest). Thus, the appearance of the animated figure may be more realistic and lifelike.

In addition to providing a more realistic appearance of the animated figure, adjusting the shape of the animated figure and the imagery projected onto the animated figure may enable the animated figure to emulate different appearances more realistically. For example, the appearance of the animated figure may be adjusted to provide a realistic and convincing mimicry of different people having different facial profiles (e.g., face shapes, facial features, facial structures, face dimensions). Thus, a single animated figure may be operated to emulate different appearances. In this manner, a cost and/or complexity associated with implementation of multiple separate animated figures dedicated to providing different visual appearances may be reduced.

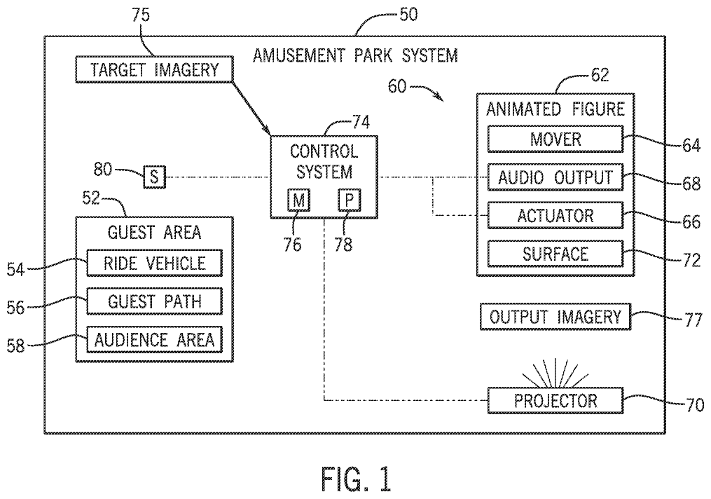

With the preceding in mind, FIG. 1 is a schematic diagram of an embodiment of an amusement park system 50. As an example, the amusement park system 50 may be a part of an attraction system, such as a ride (e.g., a roller coaster, a dark ride), a performance show, a meet and greet, and the like. As another example, the amusement park system 50 may be a part of a dining venue, a waiting area, a walkway, a shopping venue (e.g., a gift shop), or any other suitable part of an amusement park. The amusement park system 50 may include a guest area 52 where guests may be located. For instance, the guest area 52 may include a ride vehicle 54, which may move and change its position, location, and/or orientation within the amusement park system 50. The guest area 52 may additionally or alternatively, include a guest path 56 (e.g., a moving path, a stationary path) used by the guests to navigate (e.g., walk on a stationary path, walk or stand on a moving path) through the amusement park system 50, such as outside of the ride vehicle 54. The guest area 52 may further include an audience area 58 (e.g., an auditorium), which may include seating areas and/or standing areas, where guests may be positioned. Indeed, the guest area 52 may include any suitable feature to accommodate the guests within the amusement park system 50.

The amusement park system 50 may also include a show effect system 60 configured to provide entertainment to the guests of the guest area 52. For example, the show effect system 60 may include an animated figure 62, which may have a mover 64 (e.g., electrical machinery, mechanical machinery, electromechanical machinery, pneumatic machinery, hydraulic machinery) that may be actuated to cause movement or orientation of the animated figure 62 (e.g., an entirety of the animated figure 62), such as to rotate and/or translate the animated figure 62. The animated figure 62 may also include an actuator 66 that may be actuated to move different portions (e.g., an arm, a torso) of the animated figure 62 relative to one another. For example, the actuator 66 may be used to adjust a shape of the animated figure 62. The animated figure 62 may also include an audio output device 68 (e.g., a speaker) configured to provide a sound effect and further provide a realistic (e.g., lifelike) presentation of the animated figure 62. For instance, the sound effects may include spoken words to simulate a speaking action of the animated figure 62.

The show effect system 60 may also include a projector 70 (e.g., an external projector, an optical projector with lens), which may be hidden or concealed from the guests in the guest area 52 and to facilitate providing the immersive environment. The projector 70 may projection map onto a surface 72 of the animated figure 62. The surface 72 and the imagery projected onto the surface 72 via the projector 70 may be visible to the guests in the guest area 52, and the imagery may provide engaging textures that match with a geometry or contour of the surface 72 (e.g., as formed via the actuator 66). Indeed, the surface 72 may include a non-flat profile onto which the imagery may be projected in order to provide a lifelike or realistic appearance of the animated figure 62.

The show effect system 60 may further include or be communicatively coupled to a controller 74 (e.g., an electronic controller, a programmable control, an automation controller, a cloud computing system, control circuitry) configured to operate to enhance the realistic portrayal of the animated figure 62. The controller 74 may include a memory 76 and a processor 78 (e.g., processing circuitry). The memory 76 may include volatile memory, such as random-access memory (RAM), and/or non-volatile memory, such as read-only memory (ROM), optical drives, hard disc drives, solid-state drives, or any other non-transitory computer-readable medium that includes instructions (e.g., processor input instructions) to operate components of the amusement park system 50. The processor 78 may be configured to execute such instructions. For example, the processor 78 may include one or more application specific integrated circuits (ASICs), one or more field programmable gate arrays (FPGAs), one or more general purpose processors, or any combination thereof.

The controller 74 may for example, be communicatively coupled to and configured to instruct the projector 70 to control projection mapping onto the animated figure 62. In an embodiment, the controller 74 may transmit image data to the projector 70 and instruct the projector 70 to projection map imagery onto the animated figure 62 using the image data. The imagery projected onto the animated figure 62 may provide a realistic appearance of the animated figure 62. By way of example, the image data transmitted by the controller 74 may accommodate a profile, such as a contour, a geometry, a shape, an outline, a surface area, a volume, and so forth, of the surface 72 of the animated figure 62, such that the imagery projected based on the image data provides the realistic appearance of the animated figure 62.

Additionally, in an embodiment, the controller 74 may be communicatively coupled to the mover 64 and/or to the actuator 66. The controller 74 may be configured to instruct the mover 64 to move the animated figure 62 within the amusement park system 50. The controller 74 may also be configured to instruct the actuator 66 to adjust a shape of the animated figure 62. By way of example, operation of the mover 64 and/or of the actuator 66, via instructions from the controller 74, may adjust a positioning of the surface 72 relative to the projector 70. In response to the adjusted positioning of the surface 72 relative to the projector 70, the controller 74 may adjust the imagery projected by the projector 70 onto the surface 72. In this manner, the controller 74 may synchronize output of the imagery with the movement of the animated figure 62 to maintain a desirable (e.g., realistic (e.g., lifelike)) appearance of the animated figure 62.

The controller 74 may be communicatively coupled to a sensor 80, such as an optical sensor (e.g., a camera, a color sensor), a position sensor (e.g., a laser scanner, a light detection and ranging sensor), and the controller 74 may be configured to receive sensor data (e.g., captured imagery, position data) from the sensor 80 and to operate based on the sensor data. For example, the sensor 80 may be configured to monitor the positioning and/or orientation of the animated figure 62, such as relative to the projector 70, and transmit the sensor data indicative of the positioning and/or orientation to the controller 74. The controller 74 may then instruct the projector 70 to project imagery onto the surface 72 in a desirable (e.g., realistic, lifelike) manner, (e.g., based on the positioning and/or orientation of the surface 72). In an additional or alternative embodiment, the sensor 80 may monitor a parameter of the amusement park system 50, such as a time of operation, a parameter of a guest in the guest area 52 (e.g., an interaction between the guest and the animated figure 62), a parameter of another prop of the amusement park system 50, another suitable parameter, or any combination thereof. The controller 74 may then instruct the mover 64 and/or the actuator 66 to adjust the animated figure 62 and/or instruct the projector 70 to adjust the imagery projected onto the surface 72 based on sensor data indicative of the parameter.

In an embodiment, the controller 74 may determine a target appearance for the animated figure 62. For instance, the controller 74 may receive a target imagery 75, such as of a person, an animal, an alien, and the like. As an example, the controller 74 may receive the target imagery 75 by retrieving the target imagery 75, such as computer-generated characters, from a storage (e.g., the memory 76). As another example, the controller 74 may determine an appearance of an object (e.g., a guest in the guest area 52) in a surrounding environment via the sensor 80 (e.g., a camera, such as a high pixel camera or z depth camera that may determine three-dimensional imagery), and the controller 74 may determine the target imagery 75 based on the appearance. As a further example, the controller 74 may receive a user input indicative of the target imagery 75. The user input may include a selection of the target imagery 75 from a collection of possible target imagery 75 and/or from user-created or modified imagery.

Based on the target appearance, the controller 74 may instruct the mover 64 and/or the actuator 66 to adjust the positioning, orientation, and/or profile of the animated figure 62. The controller 74 may also generate image data based on the target appearance and transmit the image data to the projector 70 for projection of an output imagery 77 onto the surface 72. Such operation to move (e.g., adjust the positioning of, orientation of, and/or profile of)the animated figure 62 and to project the output imagery 77 onto the animated figure 62 may cooperatively adjust the appearance of the animated figure 62 toward the target appearance. Thus, the movement of the animated figure 62 and the projection of the output imagery 77 onto the animated figure 62 may collectively cause the animated figure 62 to emulate the target appearance, such as to provide a realistic appearance to the guests.

The controller 74 may additionally or alternatively instruct the operation of the audio output device 68 to increase the realistic effects provided by the animated figure 62. For example, the controller 74 may instruct the coordination or synchronization the visual appearance of the animated figure 62 with the audio effects provided by the animated figure 62 to present the animated figure 62 more realistically. In an embodiment, the sensor 80 may record audio feedback from an audio source, such as a voice of a guest in the guest area 52 or an actor that is hidden from view, and the sensor 80 may transmit sensor data indicative of the audio feedback to the controller 74. The controller 74 may determine characteristics of the audio feedback and instruct the audio output device 68 to output audio effects based on the characteristics to emulate the audio source (e.g., the guest or actor). In other words, the controller 74 may use the characteristics of the audio feedback provided by an audio source to instruct the generation of additional audio effects that may appear to be generated by the audio source. As such, operation of the audio output device 68 may further present the animated figure 62 in a realistic manner. Further, the audio (e.g., audio input and/or audio output) may be correlated to certain other manipulations related to the animated figure 62. For example, certain audio may correlate to certain positions of the mover 64 and/or the actuator 66. Likewise, certain audio may correlate to particular imagery projected onto the surface 72. Such correlations may be identified by an algorithm or lookup table that facilitates realistic associations between audio and visual aspects. For example, when humans mouth certain words at certain intensities (as indicated by the audio), the human face may assume certain shapes, and those shapes may be mimicked via operation of the mover 64 and/or of the actuator 66 and punctuated by the imagery projected onto the surface 72. As a specific example, to mimic the animated figure 62 coughing, in addition to instructing the audio output device 68 to emit a cough sound, the controller 74 may instruct the actuator 66 to extend a mouth portion of the animated figure 62 and to instruct the projector 70 to project the output imagery 77 that mimics opening of the mouth portion.

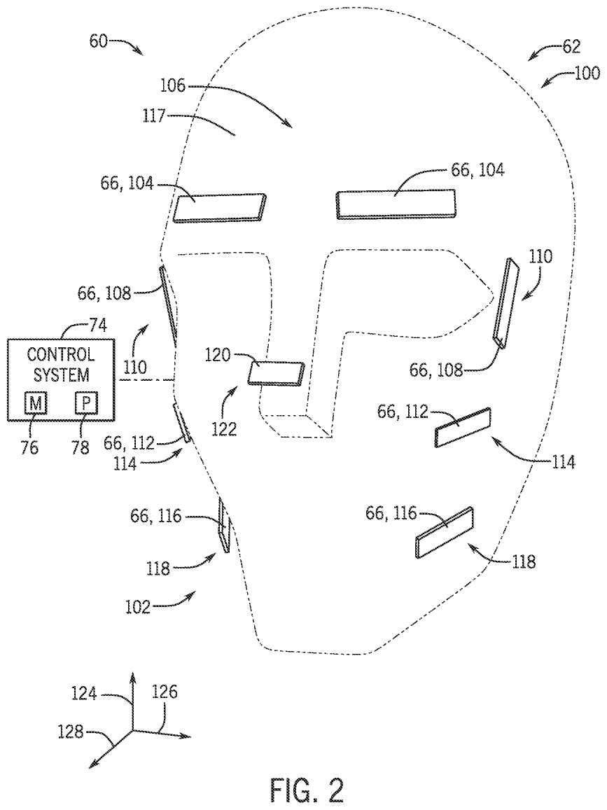

FIG. 2 is a perspective view of an embodiment of a portion of the show effect system 60 in which the controller 74 instructs the operation of the animated figure 62 in a first configuration 100. Certain portions of the animated figure 62, such as an exterior cover or layer, are not shown for purposes of visualization of an interior of the animated figure 62. In the illustrated embodiment, the animated figure 62 includes one or more facial actuators (e.g., a subset of the actuators 66, such as micro actuators, of FIG. 1) communicatively coupled to the controller 74. The facial actuators may be internal to the animated figure 62 and enclosed by the exterior cover of the animated figure 62 at a face 102 of the animated figure 62. For example, the exterior cover may provide an appearance of skin of the animated figure 62, and the exterior cover may be flexible to enable the positioning and/or actuation of the facial actuators to establish a shape of the exterior cover, thereby forming a face shape (e.g., a facial profile, a facial geometry, a facial structure) of the animated figure 62.

The controller 74 may instruct the facial actuators to actuate (e.g., extend, retract, rotate), thereby adjusting a shape or profile of the face 102, such as to form a desirable face shape (e.g., based on a target appearance). For example, the controller 74 may instruct the operation of first facial actuators 104 to adjust a structure of a forehead area 106 (e.g., a frontal bone shape) of the animated figure 62, second facial actuators 108 to adjust a structure of an eye area 110 (e.g., an orbital bone shape) of the animated figure 62, third facial actuators 112 to adjust a structure of a cheek area 114 (e.g., a cheek bone shape) of the animated figure 62, fourth facial actuators 116 to adjust a structure of a jaw area 118 (e.g., a mandible shape) of the animated figure 62, a fifth facial actuator 120 to adjust a structure of a nasal area 122 (e.g., a nasal cartilage shape) of the animated figure 62, and/or any other suitable actuators to adjust structure of the face 102 of the animated figure 62. Although the techniques discussed herein primarily refer to adjusting the appearance of the face 102 of the animated figure 62, it should be noted that similar techniques may be used to adjust the appearance of any other portion of the animated figure 62, such as another portion of a head, a portion of a torso, a portion of an appendage, and so forth, of the animated figure 62.

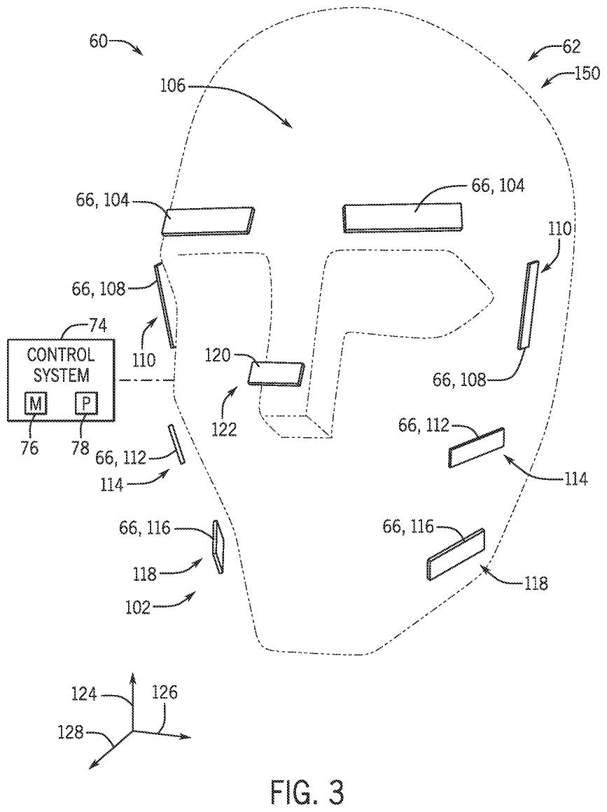

As an example, the controller 74 may instruct the facial actuators 104, 108, 112, 116, 120 to actuate relative to one another to adjust the shape of the face 102. For instance, each facial actuator 104, 108, 112, 116, 120 may be dynamically coupled to a base 117, which establishes a foundation of the face 102, and the controller 74 may instruct any of the facial actuators 104, 108, 112, 116, 120 to actuate in directions parallel to a first axis 124 (e.g., a vertical axis), directions parallel to a second axis 126 (e.g., a lateral axis), directions parallel to a third axis 128 (e.g., a longitudinal axis), or any combination thereof along the base 117. By way of example, in the first configuration 100 (which may be compared to a second configuration 150 in FIG. 3), the first facial actuators 104 may be positioned relatively low along a direction parallel to the first axis 124, the second facial actuators 108 may be positioned relatively close to one another along a direction parallel to the second axis 126, the third facial actuators 112 may be positioned relatively high along a direction parallel to the first axis 124 and relatively close to one another along a direction parallel to the second axis 126, and/or the fourth facial actuators 116 may be positioned relatively high along a direction parallel to the first axis 124 and relatively close to one another along a direction parallel to the second axis 126. Additionally or alternatively, the controller 74 may instruct any of the facial actuators 104, 108, 112, 116, 120 to actuate in rotational directions, such as about an axis extending parallel to the first axis 124, an axis extending parallel to the second axis 126, and/or an axis extending parallel to the third axis 128 to adjust the shape of the face 102. Indeed, the controller 74 may instruct the facial actuators 104, 108, 112, 116, 120 to actuate in any suitable manner to adjust the face 102 to a desirable face shape.

FIG. 3 is a perspective view of an embodiment of a portion of the show effect system 60 in which the controller 74 instructs the operation of the animated figure 62 in a second configuration 150. By way of example, the controller 74 may instruct actuation of the facial actuators (e.g., 104, 108, 112, 116, 120) relative to one another to transition the animated figure 62 from the first configuration 100 of FIG. 2 to the illustrated second configuration 150 of FIG. 3. For instance, the controller 74 may instruct the first facial actuators 104 to actuate upwardly (e.g., positively) in a direction parallel to the first axis 124, instruct the second facial actuators 108 to actuate away from one another in a direction parallel to the second axis 126, instruct the third facial actuators 112 to actuate downwardly (e.g., negatively) in a direction parallel to the first axis 124 and away from one another in a direction parallel to the second axis 126, and/or instruct the fourth facial actuators 116 to actuate downwardly in a direction parallel to the first axis 124 and away from one another in a direction parallel to the second axis 126 to transition the animated figure 62 to the second configuration 150. Such actuation of the facial actuators 104, 108, 112, 116, 120 may adjust the shape of the face 102, or a face shape, of the animated figure 62. For example, a portion of an external cover extending from one of the third facial actuators 112 to another of the third facial actuators 112 and/or extending from one of the fourth facial actuators 116 to another of the fourth facial actuators 116 may expand as a result of the actuation of the third facial actuators 112 away from one another in a direction parallel to the second axis 126, thereby increasing a dimension of the face 102 extending from the third facial actuators 112 and/or at the fourth facial actuators 116. As a result, the shape of the surface 72 of the animated figure 62 onto which imagery is projected may be adjusted.

In an embodiment, the controller 74 may be configured to instruct the facial actuators 104, 108, 112, 116, 120 to actuate independently of one another. As an example, the controller 74 may instruct the first facial actuators 104 to actuate (e.g., in a direction parallel to the first axis 124) and instruct the fifth facial actuator 120 to pause actuation or maintain a state of non-actuation. As another example, the controller 74 may instruct one of the first facial actuators 104 to actuate (e.g., in a direction parallel to the first axis 124) and instruct another of the first facial actuators 104 to pause actuation or maintain a state of non-actuation. Thus, actuation of the facial actuators 104, 108, 112, 116, 120 may be better controlled by the controller 74 to adjust the face shape of the animated figure 62 more finely (e.g., more granularly).

Although usage of facial actuators 104, 108, 112, 116, 120 are used to adjust the face shape of the animated figure 62 in the illustrated embodiment, usage of other components, such as other types of actuators may be used in an additional or alternative embodiment. As an example, the facial actuators 104, 108, 112, 116, 120 may rotate to adjust positionings and change the face shape. As another example, the animated figure 62 may include bladders positioned at various areas of the face 102, and a size of the bladders may be adjusted via inflation and/or deflation (e.g., to add fluid into and remove fluid from the bladders) to change the size of different portions of the face 102, thereby adjusting the face shape. The controller 74 maybe communicatively coupled to such components and instruct operation of the components to form a desirable face shape of the animated figure 62.

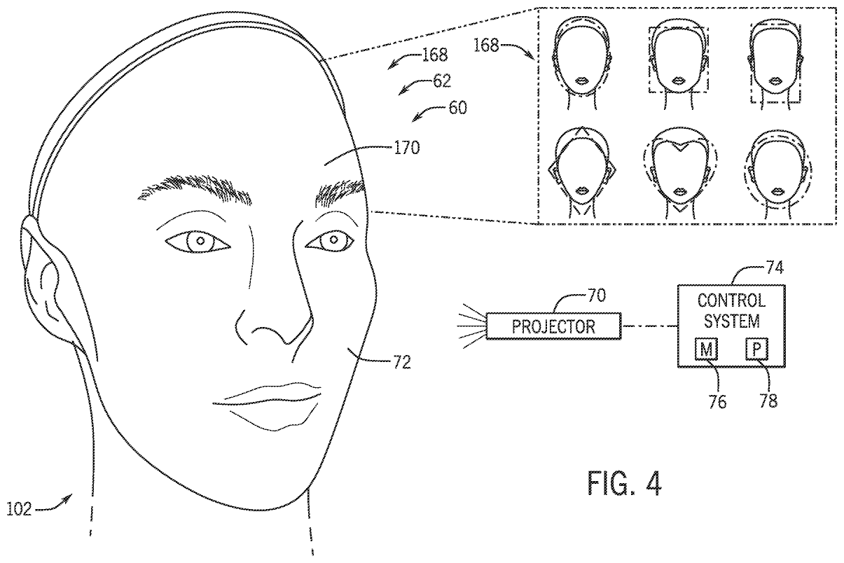

FIG. 4 is a perspective view of an embodiment of the show effect system 60. In the illustrated embodiment, the face 102 of the animated figure 62 has a face shape 168 established via positioning of the facial actuators 104, 108, 112, 116, 120. For example, the face shape 168 may include any of a variety of available face shapes 168, such as an oval, a rectangle, a diamond, a triangle, a heart, a circle, another suitable face shape, or any face shape that may be intermediate to the aforementioned face shapes. The animated figure 62 includes an external cover 170 disposed over the facial actuators and the base, thereby concealing the facial actuators from view by guests to maintain a desirable appearance of the animated figure 62. The controller 74 may instruct the projector 70 to projection map onto the external cover 170. In this manner, the external cover 170 may provide the surface 72 onto which imagery, such as an image of a human face, is projected. In an embodiment, the controller 74 may determine a target pixel (e.g., a color, a tone, an intensity) for each portion of the face 102, determine a positioning of the animated figure 62, such as a location of different portions of the face 102 in a coordinate system, and generate image data that, when communicated with the projector, enables the projector 70 to project the target pixel to each portion of the face 102 based on the positioning of the animated figure 62. Such operation may accommodate the location of the face 102, as well as the shape of the face 102, to enable the controller 74 to instruct operation of the projector 70 and instruct alignment of projected imagery with the face 102. Indeed, the controller 74 may instruct the projector 70 to adjust the imagery projected onto the face 102 based on various movements, such as rotational movement, of the animated figure 62 that may move the face 102 within the coordinate system to maintain a desired appearance of the animated figure 62 to the guests.

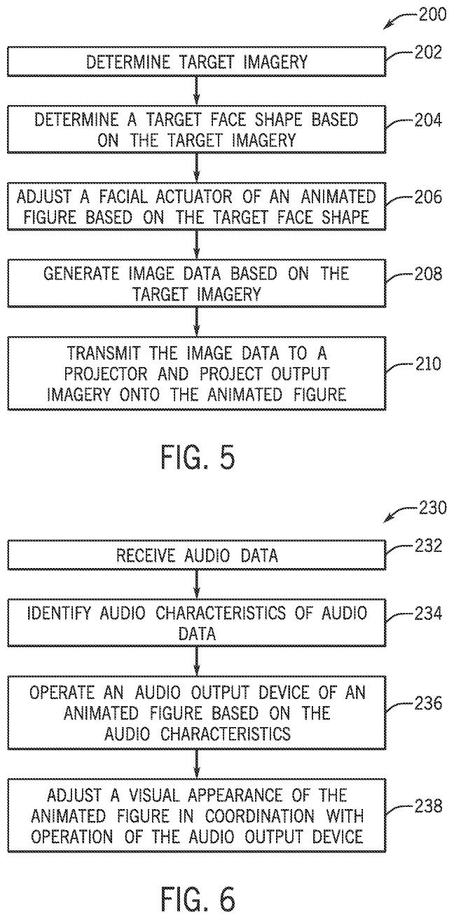

Each of FIGS. 5-7 illustrates a respective method or process associated with operation of the show effect system described herein. In an embodiment, each of the methods may be performed by a single respective component or system, such as by a controller (e.g., a processor). In an additional or alternative embodiment, multiple components or systems may perform the operations for a single one of the methods. It should also be noted that additional operations may be performed with respect to the described methods. Moreover, certain operations of the depicted methods may be removed, modified, and/or performed in a different order. Further still, the operations of any of the respective methods may be performed in parallel with one another, such as at the same time and/or in response to one another.

FIG. 5 is a flowchart of an embodiment of a method 200 for operating a show effect system to present an animated figure with a realistic appearance. At block 202, target imagery may be determined. In one embodiment, the target imagery may be retrieved from a storage, such as selected from a collection of different available imagery. In an additional or alternative embodiment, the target imagery may be determined based on sensor data, which may include captured imagery of an object (e.g., a person). For example, imagery (e.g., a still image, a video) of a guest may be captured, and target imagery corresponding to an appearance of the guest may be determined in order to mimic the appearance of the guest.

At block 204, a target face shape may be determined based on the target imagery. The target face shape may represent a geometric appearance of a face and correspond to a positioning and/or a dimension of different facial features, such as a face length, a forehead width, a cheekbone width, and/or a jawline width, relative to one another. In one embodiment, there may be one or more available face shapes (e.g., a rectangular shape, a diamond shape, a heart shape, an oval shape), and one of the face shapes may be selected based on the target imagery. In an additional or alternative embodiment, a particular face shape may be generated. In either case, the facial features of the target imagery may be identified, and the positioning of the facial features relative to one another may be determined. The target face shape may then be determined based on the positioning of the facial features relative to one another.

At block 206, one or more facial actuators of the animated figure may be adjusted based on the target face shape. For example, the facial actuator(s) may be actuated based on the target face shape (e.g., a target shape associated with detected audio or audio output). In one embodiment, a respective positioning of each facial actuator may be determined. For instance, the respective positionings of the facial actuator(s) may be pre-defined for a predetermined face shape, and each facial actuator may be actuated to its particular position mapped to the target face shape. Additionally or alternatively, the animated figure may be adjusted using another technique based on the target face shape. For instance, respective bladders may be inflated and/or deflated based on the target face shape. As a result, the face shape of the animated figure may be adjusted toward the target face shape.

At block 208, image data may be generated based on the target imagery. The image data may be generated to provide imagery that corresponds to the target imagery as projected onto the animated figure. In an embodiment, the image data may be generated via a machine learning technique, such as a generative adversarial network that may use a competing discriminative network and generative network. The generative network may create imagery via initial image data, and a discriminative network may classify the imagery created by the generative algorithm as either real or fake, such as during a calibration mode or phase. For example, during the calibration mode, the generative network may use a first model or algorithm to generate image data to create the imagery, and the discriminative network may use a second model or algorithm to classify the imagery created by the generative network as fake or real. In response to the discriminative network correctly classifying imagery (e.g., fake imagery) created by the generative network as fake, the generative network may adjust the first model and create additional imagery using the adjusted first model to attempt to cause the discriminative network to incorrectly classify the additional imagery as being real. In an embodiment, in response to incorrectly classifying imagery created by the generative network as being fake, the discriminative network may adjust the second model and attempt to correctly classify imagery. The generative network may then create subsequent imagery and attempt to cause the discriminative network to incorrectly classify the subsequent imagery using the adjusted second model. As such, the first model and/or the second model may be continually adjusted during the calibration mode, and the first model used by the generative network may be improved to create more realistic imagery. Completion of the calibration mode (e.g., after a threshold quantity of iterations in which the discriminative network incorrectly classified imagery has occurred), a finalized model for generating image data to create imagery may be obtained. The generative network may then generate the image data based on target imagery using the first model. As an example, the image data may include facial features that are positioned with respect to one another based on the target imagery. For example, the relative positioning of the facial features of the image data may be proportional to the relative positioning of the corresponding facial features of the target imagery to enable imagery projected onto the animated figure to have a similar appearance as the target imagery.

At block 210, the image data may be transmitted to the projector, and the projector may present output imagery onto the animated figure using the image data. For example, the imagery may be projected onto the face having the face shape established via the facial actuators. In this way, the face shape of the animated figure and the output imagery projected onto the animated figure may collectively correspond to the target imagery to cause the animated figure to have a similar appearance as the target imagery. As an example, the target imagery may include an image of a real-world entity, such as a person. Therefore, the animated figure emulating the target imagery via the adjusted face shape and projected output imagery may also have a realistic appearance.

The method 200 may also be performed to cause the animated figure to appear to move. For example, target imagery (e.g., a series of images) corresponding to movement of the animated figure, such as movement of eyes, movement of a mouth, movement of a cheek, may be determined (e.g., generated based on captured imagery of a real-world entity), and the face shape of the animated figure and/or the output imagery projected onto the animated figure may be adjusted based on such target imagery. That is, updated target face shapes and/or updated target imagery may be determined based on the target imagery, and facial actuators of the animated figure and/or the projector may be operated in accordance with the updated target face shapes and/or the updated target imagery. Such performance of the method 200 may enable the animated figure to provide the appearance of movement without having to implement additional components, such as separate actuators or linkages, dedicated to causing physical movement of the animated figure.

FIG. 6 is a flowchart of an embodiment of a method 230 for operating an animated figure to provide audio effects. At block 232, audio data may be received. In an embodiment, the audio data may be received as sensor data from a sensor, such as a microphone, which may capture audio feedback and transmit the sensor data having the audio data that indicates the audio feedback. For example, the audio data may indicate words spoken by a person, such as a guest or an actor (e.g., a voice actor providing entertainment via an animated figure).

At block 234, audio characteristics of the audio data may be identified. Such audio characteristics may include tone, pitch, timbre, cadence or pace (e.g., words spoken per interval of time), and the like. The audio characteristics may be unique to the audio source that provides the audio data and may therefore distinguish the received audio data from other audio data, such as audio data indicative of audio feedback provided by another audio source.

At block 236, an audio output device of the animated figure may be operated based on the audio characteristics. By way of example, the audio output device may be operated to provide audio effects in accordance with the audio characteristics. For instance, words spoken by a person may be detected, and audio effects may be generated based on the detected words to mimic the person's unique voice speaking other words (e.g., pre-determined dialogue, newly generated dialogue). As such, the animated figure may appear to have the speaking mannerisms of the person. In this manner, in addition to mimicking the visual appearance of the person (e.g., via facial actuators, via output imagery), the animated figure may be operated to mimic the sounds provided by the person, thereby further mimicking the person in a realistic and convincing manner.

At block 238, a visual appearance of the animated figure may be adjusted in coordination with the operation of the audio output device. As an example, actuation of the facial actuators and/or adjustment of output imagery may be associated with respective, corresponding audio effects (e.g., particular words) to be provided by the audio output device. For instance, the facial actuators and/or the output imagery may be operated to present movement of a mouth (e.g., opening/closing the mouth), movement of an eye, movement of a cheek, and so forth, during output of the audio effects. As an example, target imagery representative of an appearance of the animated figure may be determined and/or updated based on the operation of the audio output device (e.g., an elongated face shape with an output imagery of an open mouth may be determined as the target imagery to mimic a cough). Thus, in response to determining that an audio effect is to be provided by the audio output device, the corresponding actuation of the facial actuators and/or the corresponding adjustment of the output imagery may be effectuated. As such, the animated figure may also visually appear to be providing the audio effects, thereby increasing the realistic appearance of the animated figure

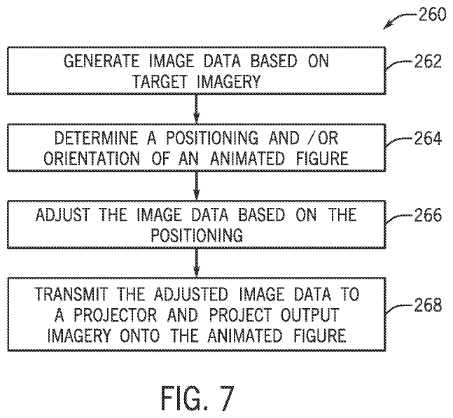

FIG. 7 is a flowchart of a method 260 for operating a show effect system to present an animated figure with a realistic appearance. At block 262, image data is generated based on target imagery using the techniques discussed herein. For example, the image data may be generated to correspond to the target imagery, as well as to accommodate the face shape of the animated figure.

At block 264, a positioning and/or orientation of an animated figure may be determined. The positioning and/or orientation of the animated figure may indicate a positioning and/or orientation of a surface with respect to a projector configured to project the imagery onto the surface. For example, the positioning and/or orientation may include a location and/or orientation of the animated figure within a coordinate system (e.g., a virtual coordinate system).

At block 266, the generated image data is adjusted based on the positioning and/or orientation of the animated figure. By way of example, the image data may be adjusted to accommodate the perspective that guests have of the animated figure at the positioning and/or orientation of the animated figure. For instance, certain virtual elements of the image data, such as facial features, may be angled or moved to correspond to the appearance of the animated figure that the guests may see at the positioning and/or orientation of the animated figure. The position and/or orientation of the guest may be known based on the location of a designated viewing area, and/or the position and/or orientation of the guest may be monitored so that relative positioning and/or orientation changes cause updates to the image data and/or operation of the animated figure.

At block 268, the adjusted image data may be transmitted to the projector to instruct the projector to present output imagery onto the animated figure using the adjusted image data. The output imagery projected onto the animated figure may be presented in a more desirable manner based on the perspective of the guests at the positioning and/or orientation of the animated figure. For example, realistic mimicry of the target imagery via the animated figure may be maintained.

For instance, the animated figure may include various facial features positioned and/or oriented on its face. As the animated figure turns its face, the output imagery may be projected onto the animated figure to maintain the position and/or orientation of the facial features on the face. In other words, the relative positioning and or orientation between the facial features and the face may appear to be relatively fixed, such as to provide an appearance that the facial features of the animated figure are turning with the face of the animated figure. Indeed, portions of the target imagery may be mapped to corresponding portions of the face to provide the realistic appearance of the animated figure. The image data may be adjusted to enable the output imagery to be projected onto the animated figure based on the mapping of the portions of the target imagery to the corresponding portions of the face. Thus, as the position and/or orientation of the animated figure adjusts, the desirable appearance of the animated figure based on the target imagery may be maintained.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. An amusement park system, comprising:
an animated figure comprising one or more actuators configured to adjust a shape of a surface;
a projector configured to project imagery onto the surface; and
a controller configured to perform operations comprising:
determining target imagery;
instructing an actuator of the one or more actuators to actuate to adjust the shape of the surface based on the target imagery;
generating output imagery based on the target imagery; and
instructing the projector to project the output imagery onto the surface.

2. The amusement park system of claim 1, comprising one or more sensors communicatively coupled to the controller, wherein:
the one or more sensors are configured to capture an image of an object and transmit sensor data indicative of the image of the object to the controller, and
the controller is configured to determine the target imagery based on the sensor data.

3. The amusement park system of claim 1, wherein the controller is configured to determine the target imagery by retrieving the target imagery from a storage.

4. The amusement park system of claim 1, wherein the animated figure comprises a base, and the controller is configured to cause an adjustment of the extent of actuation of the one or more actuators by instructing the one or more actuators to actuate along the base to adjust the shape of the surface.

5. The amusement park system of claim 4, wherein the animated figure comprises an external cover that encloses and conceals the base and the one or more actuators, wherein the external cover comprises the surface onto which the projector is configured to project the output imagery.

6. The amusement park system of claim 1, wherein the animated figure comprises an audio output device, and the controller is configured to instruct the audio output device to provide audio effects.

7. The amusement park system of claim 6, comprising one or more sensors communicatively coupled to the controller, wherein the one or more sensors are configured to detect audio feedback and transmit sensor data indicative of the audio feedback to the controller, and the controller is configured to perform operations comprising:
identifying audio characteristics based on the sensor data; and
instructing the audio output device to provide the audio effects based on the audio characteristics to simulate the audio feedback.

8. The amusement park system of claim 7, wherein the controller is configured to actuate a subset of the one or more actuators to adjust the shape of the surface based on the audio effects provided by the audio output device.

9. A non-transitory computer-readable medium, comprising processor input instructions that, when executed by a processor, are configured to cause the processor to perform operations comprising:
determining target imagery;
determining a target face shape of an animated figure based on the target imagery;
instruct an adjustment of one or more actuators of the animated figure based on the target face shape to adjust a shape of a surface of the animated figure;
generating image data based on the target imagery; and
transmitting the image data to a projector and instruct the projector to project output imagery based on the image data onto the surface of the animated figure.

10. The non-transitory computer-readable medium of claim 9, wherein the processor input instructions, when executed by the processor, are configured to cause the processor to select the target face shape from one or more face shapes based on the target imagery.

11. The non-transitory computer-readable medium of claim 10, wherein each face shape of the one or more face shapes is associated with a respective, corresponding position of the one or more actuators, and the processor input instructions, when executed by the processor, are configured to cause the processor to output instructions to adjust at least one actuator of the one or more actuators of the animated figure by instructing the at least one actuator of the one or more actuators to actuate to a respective, corresponding position associated with the target face shape.

12. The non-transitory computer-readable medium of claim 9, wherein the processor input instructions, when executed by the processor, are configured to cause the processor to determine the target imagery based on imagery of an object, the imagery being captured by one or more sensors.

13. The non-transitory computer-readable medium of claim 9, wherein the processor input instructions, when executed by the processor, are configured to cause the processor to perform operations comprising:
receiving audio data indicative of audio feedback captured by one or more sensors;
identifying audio characteristics of the audio data; and
outputting instructions to an audio output device of the animated figure to provide audio effects based on the audio characteristics to simulate the audio feedback.

14. The non-transitory computer-readable medium of claim 9, wherein the processor input instructions, when executed by the processor, are configured to cause the processor to perform operations comprising:
determining a positioning and/or orientation of the animated figure;
adjusting the image data based on the positioning and/or orientation of the animated figure to provide adjusted image data; and
transmitting the adjusted image data to the projector and output instructions to the projector to adjust the output imagery projected onto the surface of the animated figure based on the adjusted image data.

15. The non-transitory computer-readable medium of claim 14, wherein the positioning and/or orientation of the animated figure comprises a relative positioning and/or orientation between the surface of the animated figure and the projector.

16. The non-transitory computer-readable medium of claim 9, wherein the processor input instructions, when executed by the processor, are configured to cause the processor to instruct the one or more actuators to actuate along a base of the animated figure to adjust the shape of the surface of the animated figure.

17. An amusement park system, comprising:
an animated figure comprising one or more actuators;
one or more sensors configured to capture first imagery of a person;
a projector configured to project second imagery onto the animated figure; and
a controller communicatively coupled to the one or more sensors, wherein the controller is configured to perform operations comprising:
receiving sensor data indicative of the first imagery of the person from the one or more sensors;
instructing the one or more actuators of the animated figure to actuate based on the sensor data to adjust a shape of a face of the animated figure;
generating the second imagery based on the first imagery; and
causing the projector to project the second imagery onto the face of the animated figure having the shape adjusted based on the sensor data to mimic an appearance of the person.

18. The amusement park system of claim 17, wherein the one or more actuators comprise one or more initially-actuated actuators, and the controller is configured to instruct one or more additional actuators to actuate based on the sensor data to adjust a dimension of the face extending from the one or more initially-actuated actuators to the one or more additional actuators.

19. The amusement park system of claim 17, wherein the controller is configured to perform operations comprising:
determining a target face shape based on the sensor data; and
instructing the one or more actuators to actuate to adjust the shape of the face based on the target face shape.

20. The amusement park system of claim 17, wherein the animated figure comprises an audio output device, and the controller is configured to:
operate the audio output device to provide audio effects; and
instruct the one or more actuators to actuate in coordination with the audio effects.
